(19) United States
(12) Patent Application Publication
(10) Pub. No.: US 2004/0201181 A1
(43) Pub. Date: Oct. 14, 2004

(54) Flange seal

(76) Inventors: Alexander S. Williamson, Fort Wayne, IN (US); Troy D. McArthy, Auburn, IN (US); Russell Schwarz, Avilla, IN (US); David LaPalm, Fort Wayne, IN (US); Rohit Ramkumar, Woodridge, IL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/409,736

(22) Filed: Apr. 9, 2003

(51) Int. Cl. F02F 11/00

(52) U.S. Cl. 277/592

(57) ABSTRACT

A seal for a flange includes two separate sealing lips to seal the interfaces between the flange and the intake manifold and the cylinder head. One lip seals against the head surface when the flange is bolted to the cylinder head. The other lip seals around the intake manifold when the intake manifold, such as a tubular intake manifold, is inserted into the flange. The flange seal is made of elastomeric material, such as rubber, and is integrally bonded to the flange made of metal, such as steel or aluminum, during the molding process to form a flange seal having a one-piece construction. The flange seal also includes a gap between one of the sealing lips and an outer surface of the flange that provides a space for the displaced rubber to flow when compressed by the cylinder head. It is emphasized that this abstract is provided to comply with the rules requiring an abstract that will allow a searcher or other reader to quickly ascertain the subject matter of the technical disclosure.

### TECHNICAL FIELD

The present invention relates generally to improvements in manufacturing sealing components that interface with internal combustion engines, such as air intake manifolds and cylinder heads. More particularly, the invention relates to a seal integrally bonded to a flange for sealing the interface between the flange and a cylinder head of an engine and the interface between the flange and an air intake manifold.

### BACKGROUND OF THE INVENTION

Intake manifolds for automotive engines typically are comprised of a plenum or chamber having an open end and an opposite closed end and defining a plurality of outlet holes therebetween. The intake manifold also includes a plurality of tubes having first ends joined with the outlet holes of the plenum and opposite second ends connected with associated holes of a flange member which is adapted for mounting to a cylinder head of an engine.

Flange seals for air intake manifolds have been developed for many years. The flange seal prevents air from entering the intake of the combustion chamber. However, one problem associated with conventional flange seals is that the seal will “extrude” when the flange is tightened against the cylinder head of the internal combustion engine. As a result, the flange seal will leak unwanted air into the combustion chamber.

### SUMMARY OF THE INVENTION

The inventors of the present invention have recognized these and other problems associated with conventional flange seals. To this end, the inventor has developed a seal integrally bonded to a flange for an intake manifold. The seal includes a first lip and a second lip, wherein the first lip seals the surface of a cylinder head when the flange is bolted to the cylinder head of an internal combustion engine, and wherein the second lip seals the intake manifold when the intake manifold is inserted into the flange.

### BRIEF DESCRIPTION OF THE DRAWINGS

The present invention will now be described, by way of example, with reference to the accompanying drawings, in which:

FIG. 1 is a side view of an intake manifold inserted into a flange with a seal integrally bonded to the flange according to the invention;

FIG. 2 is a top view of the seal of the invention integrally bonded to the flange when the intake manifold is inserted into the flange as shown in FIG. 1;

FIG. 3 is a cross-sectional view of the seal of the invention integrally bonded to the flange when the intake manifold is inserted into the flange taken along line 3-3 of FIG. 2;

FIG. 4 is an enlarged view of FIG. 3 of the seal of the invention integrally bonded to the flange; and

FIG. 5 is an enlarged view of FIG. 3 of the seal of the invention integrally bonded to the flange when a cylinder head is bolted to the flange and the intake flange is inserted into the flange.

### DESCRIPTION OF THE PREFERRED EMBODIMENT

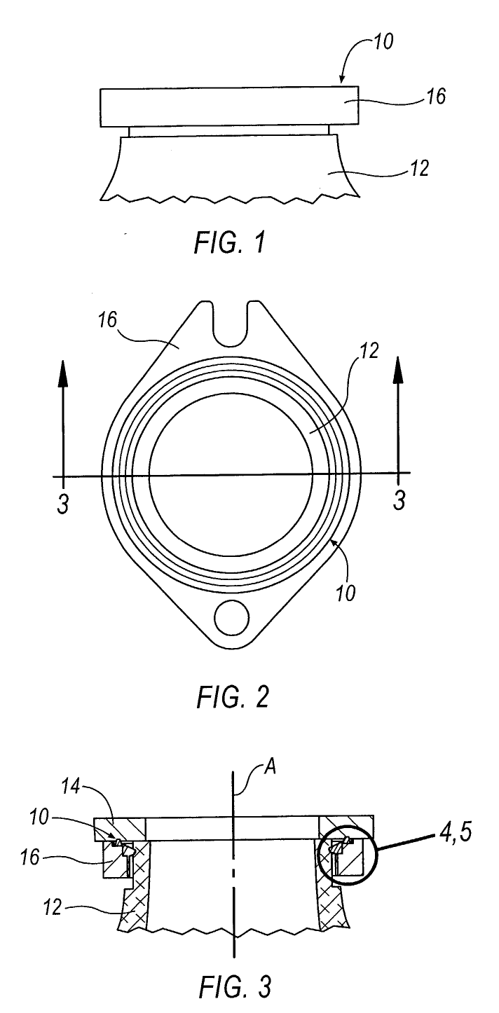

Referring to FIGS. 1-5, a seal, shown generally at 10, is illustrated in accordance with the invention. The seal 10 is adapted for sealing a flange 16 when an intake manifold 12 is inserted into the flange 16 and a cylinder head 14 is bolted to the flange 16. In the illustrated embodiment, the intake manifold 12 is defined as a tubular intake manifold 12 with a longitudinal axis, A, of a type used in, for example, a multi-cylinder internal combustion engine with two banks of cylinders in V formation, such as a motorcycle engine or the like. However, the invention is not limited by the shape of the intake manifold, and the invention can be practiced with intake manifold having a different shape, such as elliptical, or the like.

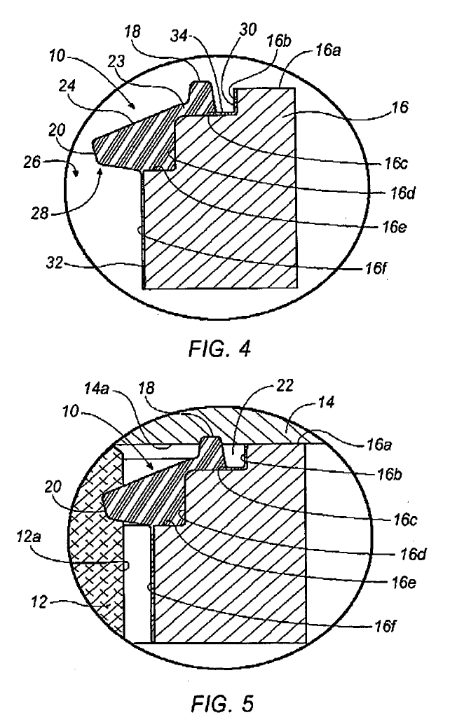

The seal 10 is made of a single piece of elastomeric material of a type well-known in the art, such as rubber, or the like. The flange 16 is made of metal material, such as steel, aluminum, or the like, and can be formed by forging, a powdered metal process, or any other conventional process known in the art. In cross-section, the flange 16 has a step configuration that includes three vertical outer surfaces 16b, 16d and 16f and a pair of horizontal outer surfaces 16c and 16e for accommodating the seal 10, as best shown in FIGS. 4 and 5. It should be noted that the flange 16 also includes an additional horizontal outer surface 16a that forms an interface between the flange 16 and the cylinder head 14.

The seal 10 includes a pair of sealing lips 18 and 20. One sealing lip 18 seals against a surface 14a of the cylinder head 14 when the cylinder head 14 is attached to the flange 16, and the other sealing lip 20 seals around an outer surface 12a of the tubular intake manifold 12. While the outer surface of the sealing lip 18 is substantially perpendicular to the longitudinal axis, A, of the intake manifold 12, the outer surface of the sealing lip 20 is provided at an angle 28 with respect to the longitudinal axis, A, of the intake manifold 12. The angle 28 allows the intake manifold 12 to be properly positioned when inserted into the flange 16.

To form an adequate seal between the flange 16 and the cylinder head 14, the sealing lip 18 extends outwardly from the outer surface 16a of the flange 16 at a distance of approximately 0.35 mm. Similarly, the sealing lip 20 extends outwardly from the outer surface 16f of the flange 16 at a distance of approximately 2.00 mm to accommodate the gap of approximately 1.20 mm between the outer surface 16f of the flange 16 and the intake manifold 12. It will be appreciated that the distance at which the sealing lips 18, 20 extend outwardly from the outer surface 16a, 16f depends on the intended purpose of the seal 10, and that the sealing lips 18, 20 can extend at any desired distance that will provide adequate sealing between the flange and the intake manifold and cylinder head.

A gap 22 is provided between the sealing lip 18 and the outer surface 16b of the flange 16. The gap 22 provides a space for the sealing lip 18 to be displaced when the cylinder head 14 is tightened against the flange 16, thereby ensuring an airtight seal between the flange 16 and the cylinder head 14 when the cylinder head 14 is tightened. The seal 10 includes relatively thin portions 30, 32 that cover the outer surfaces 16b, 16f of the flange 16, respectively. The thin portion 32 that covers the outer surface 16f of the flange 16 provides a cushioning effect between the flange 16 and the intake manifold 12. In addition, a relatively thin portion 34 is provided along the outer surface 16c to form the gap 22 mentioned above.

The seal 10 also includes a first portion 22 that extends from the sealing lip 18 substantially parallel to the outer surface 16c of the flange 16 and substantially perpendicular to the longitudinal axis, A, of the intake manifold 12. By extending the seal 10 from the sealing lip 18 in this manner, the first portion 22 provides a sufficient thickness to the seal 10 and provides structural support for the sealing lip 18, particularly between the step between the horizontal and vertical outer surfaces 16c and 16d, respectively. In addition, the seal 10 includes a second portion 24 that extends from the first portion 22 to the sealing lip 20 at an angle 26 with respect to the longitudinal axis, A, of the intake manifold 12. Thus, the second portion 24 is formed at the angle 26 with respect to the first portion 22.

One aspect of the invention is that the seal 10 made of a single piece of elastomeric material is integrally bonded to the metal flange 16. To integrally bond the elastomeric seal 10 to the metal flange 16, the flange 16 is inserted into a mold (not shown), and an adhesive material is applied to the outer surfaces 16b-16f of the flange 16 to chemically bond the elastomeric material to the flange 16. The adhesive material can be applied to the outer surfaces 16b-16f in a separate process prior to the flange 16 is inserted into the mold. Then, the elastomeric material forming the seal 10 is injected into the mold to integrally and permanently bond the seal 10 to the metal flange 16. By integrally bonding the seal 10 to the flange 16, the seal 10 and flange 16 becomes a one-piece unit, thereby making the purchasing, handling and installing of the seal 10 and flange 16 simpler and easier, as compared to conventional designs in which the seal and flange are two separate pieces.

It should be understood that the aforementioned and other various alternatives to the embodiments of the invention described herein may be employed in practicing the invention. It is intended that the following claims define the scope of the invention and that the method and apparatus within the scope of these claims and their equivalents be covered thereby.

1-8. (Cancelled)

9. A seal for sealing a flange between an intake manifold and a cylinder head of an internal combustion engine comprising:
a first sealing lip for sealing a surface of said cylinder head when said flange is bolted to said cylinder head;
a second sealing lip for sealing a surface of said intake manifold; and
a relatively thin portion that extends from a surface of said second sealing lip, opposite said first sealing lip, for providing a cushioning effect between said flange and said intake manifold;
wherein said seal is bonded to said flange.

10. The seal according to claim 9, wherein said seal further comprises a first portion and a second portion, said second portion being formed at an angle with respect to said first portion.

11. The seal according to claim 9, wherein one of said first and second sealing lips is formed at an angle with respect to a longitudinal axis of said intake manifold.

12. The seal according to claim 9, wherein said seal further comprises a gap disposed between said first lip and a vertical outer surface of said seal for providing a relief space when said seal is displaced.

13. The seal according to claim 9, wherein said flange forms a step configuration in cross section that includes a plurality of horizontal and vertical outer surfaces.

14. A seal for sealing a flange between an intake manifold and a cylinder head of an internal combustion engine comprising:
a first sealing lip for sealing a surface of said cylinder head when said flange is bolted to said cylinder head;
a gap disposed between said first lip and a vertical outer surface of said seal for providing a relief space when said seal is displaced
a second sealing lip for sealing a surface of said intake manifold; and
a relatively thin portion that extends from a surface of said second sealing lip, opposite said first sealing lip, for providing a cushioning effect between said flange and said intake manifold;
wherein said seal is bonded to said flange.

15. The seal according to claim 14, wherein said seal further comprises a first portion and a second portion, said second portion being formed at an angle with respect to said first portion.

16. The seal according to claim 14, wherein one of said first and second sealing lips is formed at an angle with respect to a longitudinal axis of said intake manifold.

17. The seal according to claim 14, wherein said flange forms a step configuration in cross section that includes a plurality of horizontal and vertical outer surfaces.
